(19) United States
(12) Patent Application Publication
(10) Pub. No.: US 2016/0170225 A1
(43) Pub. Date: Jun. 16, 2016

(54) ANTI-SPECKLE TRANSMISSIVE DIFFUSER SCREEN

(71) Applicant: COMMISSARIAT A L'ENERGIE ATOMIQUE ET AUX ENERGIES ALTERNATIVES, Paris (FR)

(72) Inventors: Stéphane GETIN, Grenoble (FR); Umberto ROSSINI, Coublevie (FR)

(21) Appl. No.: 14/904,849

(22) PCT Filed: Jul. 11, 2014
(86) PCT No.: PCT/FR2014/051796

§ 371 Date: Jan. 13, 2016

(30) Foreign Application Priority Data
Jul. 15, 2013 (FR) 1356950

(51) Int. Cl. G02B 27/48; G03B 21/20; G02B 7/02; G02B 3/08; G02B 5/02

(52) U.S. Cl. CPC G02B 27/48; G02B 3/08; G02B 5/0231; G02B 5/0278; G02B 7/025; G03B 21/2033

(57) ABSTRACT

The invention relates to a transmissive diffuser screen comprising a transparent support (50), a first face of the support being covered with a first diffusive micro-structure (52) and a second face of the support being covered with an optical focusing structure (54) of which the primary focal point is disposed at a lighting source (36) of the screen and of which the surface is covered with a second diffusive micro-structure (56).

The present patent application claims the priority benefit of French patent application FR13/56950 which is herein incorporated by reference.

### BACKGROUND

The present application relates to a transmissive diffuser screen, for example, for a rear projection display device.

### DISCUSSION OF THE RELATED ART

Rear projection display devices are advantageously compatible with different rear projection supports, also called screens. They are in particular compatible with rear projection supports having curved or complex shapes. Such devices are thus particularly capable of providing information in passenger compartments of vehicles, for example cars. Indeed, rear projection display devices may for example be integrated in the central console of the passenger compartment of a car, or also above this central console.

However, devices integrated in vehicle passenger compartments are subject to significant constraints: such devices should in particular be relatively compact and sufficiently directional to avoid projections towards reflective elements such as the windshield or lateral windows. Further, such devices should ensure the generation of an output light flow sufficient to avoid problems of readability when the vehicle is placed under an illumination of high luminosity, for example, from the sun.

To limit readability problems, a cap is generally provided above the display screens in vehicle passenger compartments. However, this solution is not adapted to the integration of a screen on a significant surface area, for example, in the central console of the vehicle.

### SUMMARY

An object of an embodiment is to provide a transmissive diffuser screen capable of being integrated in a rear projection display device overcoming all or part of the disadvantages of known devices.

Thus, an embodiment provides a transmissive diffuser screen comprising a transparent support, a first side of the support being covered with a first diffusive microstructure, and a second side of the support being covered with an optical focusing structure having its surface covered with a second diffusive microstructure.

According to an embodiment, the optical focusing structure is a Fresnel lens.

According to an embodiment, the second diffusive microstructure is defined on the surface of each of the convex portions of the Fresnel lens.

According to an embodiment, the focusing structure is placed on the support by means of glue.

According to an embodiment, the support, the optical focusing structure, the first diffusive microstructure, and the second diffusive microstructure are defined in a single block.

According to an embodiment, the first diffusive microstructure and the second diffusive microstructure are formed of films placed at the surface, respectively, of the first side of the support and of the optical focusing structure.

According to an embodiment, the optical focusing structure has a focal distance in the range from 200 to 400 mm.

Another embodiment provides a rear projection device, comprising a screen of the above-mentioned type.

Another embodiment provides a central console of a vehicle, comprising a rear projection device of the above-mentioned type.

### BRIEF DESCRIPTION OF THE DRAWINGS

The foregoing and other features and advantages will be discussed in detail in the following non-limiting description of specific embodiments in connection with the accompanying drawings, among which:

FIG. 1 illustrates a portion of an instrument panel of a vehicle, for example, a car;

FIG. 2 illustrates a rear projection display device;

FIG. 3 illustrates a portion of a transmissive diffuser screen and a disadvantage of such a device;

FIG. 4 illustrates a portion of a transmissive diffuser screen according to an embodiment; and

FIG. 5 illustrates the operation of the device of FIG. 4.

For clarity, the same elements have been designated with the same reference numerals in the different drawings and, further, as usual in the representation of optical systems, the various drawings are not to scale.

### DETAILED DESCRIPTION

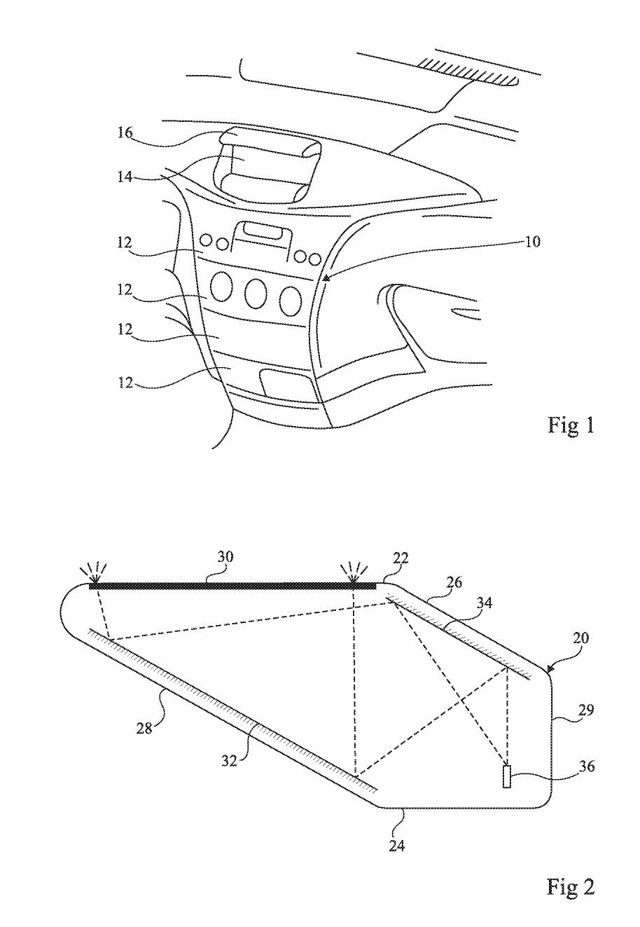

FIG. 1 illustrates a portion of the front of the passenger compartment of a vehicle, for example, a car. This drawing shows a central console 10 comprising a plurality of sections 12, each section comprising either information display screens, or buttons. Central console 10 further comprises an upper portion comprising a cavity having a display screen 14 provided at the bottom thereof. The cavity is topped with a cap 16.

The transmissive diffuser screen which is provided herein is particularly capable of being used in a rear projection display device to replace the selection of screen 14 or of the screens placed at the level of sections 12 of central console 10, or to replace the assembly of sections of the central console, without using a cap, the device being provided to be sufficiently directional to avoid projecting information towards the windshield or the lateral windows and being further sufficiently bright to be readable when the screen is reached by parasitic ambient light rays, for example, from the sun.

Further, the transmissive diffuser screen provided herein may have a curved shape and thus be integrated in the passenger compartment, and particularly in the central console, “seamlessly”, that is, in a single block at the front of the central console.

FIG. 2 illustrates a rear projection display device comprising a transmissive diffuser screen capable of being used in the passenger compartment of a car, for example, in the central console thereof.

The device comprises a package 20 having projection elements of the rear projection display device integrated therein. In the shown example, package 20 is defined by two substantially parallel first walls 22 and 24, two second walls 26 and 28 substantially parallel to each other, and a third wall 29. Walls 26 and 28 form a non-right angle with walls 22 and 24 and, more specifically, the angle between wall 26 and wall 22 is an obtuse angle and the angle between wall 22 and wall 28 is an acute angle. Wall 29 is perpendicular to walls 22 and 24 and is positioned between walls 24 and 26. Wall 24 is slightly shorter than wall 22 and wall 26 is slightly shorter than wall 28 in the plane of FIG. 2.

Package 20 comprises an output opening in wall 22 having a transmissive diffuser screen 30, for example, a holographic diffuser screen, positioned therein. Screen 30 allows the transmission of the rays reaching it on the inner side of package 20 to the outside of package 20 with a slight diffusion of these rays.

Two planar reflective mirrors 32 and 34 respectively positioned along wall 28 and wall 26 are provided inside of the package. A laser projector 36, for example, a pico projector forming an image by scanning of a laser beam, is substantially positioned at the angle between walls 24 and 29. In projector 36, the scanning is for example obtained via a rotating mirror, for example, according to a technology called DLP, for “Digital Light Processing”, in the art. Laser source 36 is positioned to illuminate mirror 34, so that the beam reflected by mirror 34 reaches mirror 32, and that the beam reflected by mirror 32 reaches transmissive holographic diffuser 30. As shown in the example of FIG. 2, source 36 may be rotatably assembled along at least two axes to be able to scan the entire surface of holographic diffuser 30, via the successive reflections on mirrors 34 and 32.

The positioning of mirror 32 relative to transmissive holographic diffuser 30, according to an acute angle, enables to provide a projection with no deformation (a square gives a square). This constraint imposes for mirror 32 to be placed relatively opposite the transmissive holographic diffuser.

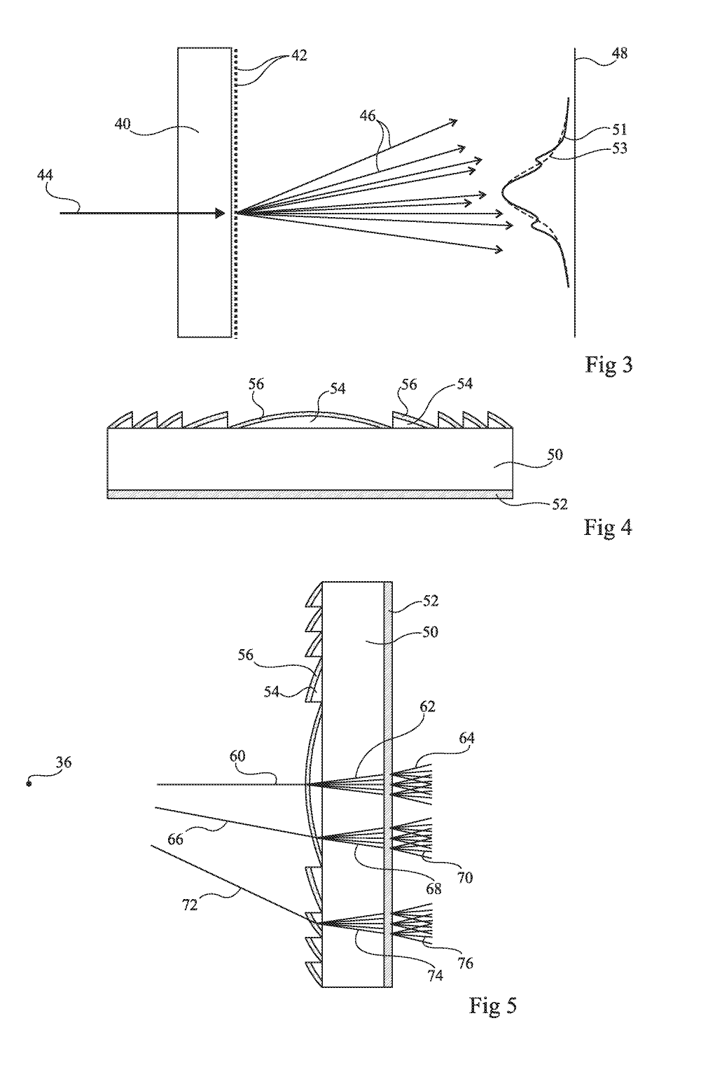

FIG. 3 illustrates a portion of a conventional transmissive diffuser screen and a disadvantage of such a screen.

The diffuser screen comprises a plate 40 having diffusive microstructures 42, ensuring a diffusion of the light beams reaching them, provided on one side thereof. Generally, microstructures 42 are placed on plate 40 of the output side thereof, that is, on its non-illuminated side. A laser beam 44 thus reaches plate 40 on the side opposite to that containing microstructures 42. The laser beam is diffused by microstructures 42, which forms a large number of diffused beams 46 at the plate output.

The right-hand side of FIG. 3 illustrates an observation screen 48 placed behind the screen. A curve 51 in full line illustrates the light intensity received at the level of observation screen 48.

As can be seen in FIG. 3, this curve is quite irregular. The irregularity of the beam originating from the diffusive screen results from the fact that laser beams have a strong coherence. When the coherent light wave hits rough surface 42 of the diffuser, it is diffracted and the produced diffracted beams, which may be optically associated with secondary light sources, interfere. This phenomenon is called speckle.

To limit speckle phenomena, it is known to use mobile diffusers, for example, rotating or mobile in translation. By selecting a motion frequency greater than the persistence of vision, the eye thus averages the speckle patterns. However, the use of mobile parts to drive the screen, in particular in the case of a large screen such as that provided in the above application, implies a significant increase of the cost of the device, while increasing the bulk and decreasing the reliability thereof.

It is thus desired to form transmissive diffuser screens where the coherence, and thus speckle phenomena, are attenuated to obtain an intensity pattern such as that illustrated in dotted lines in curve 53 in FIG. 3, that is, a curve having a general Gaussian shape, giving a “smooth” aspect to the projected image.

Further, particularly for applications such as those provided in relation with FIG. 1, it is necessary to provide diffuser screens having a spatially-controlled diffusion, to avoid projections in unwanted direction. Particularly, in the case of the application in a vehicle console, it is necessary to avoid projections towards reflective surfaces such as the windshield or the lateral windows.

Thus, to overcome all or part of the disadvantages of conventional diffusion plates, a transmissive diffuser comprising different elements enabling to suppress a great part of speckle phenomena and providing a diffusion in a controlled direction, is here provided.

FIG. 4 illustrates a portion of a transmissive diffuser screen according to an embodiment.

The screen comprises a transparent plate 50 having diffusive microstructures 52 ensuring a diffusion of rays provided on one side thereof. The side having the microstructures provided thereon is the side intended to be placed on the observer's side, that is, the output side of the transmissive diffuser screen. On the input side of the screen, that is, opposite microstructures 52, is provided an optical focusing structure 54, in the shown example, a Fresnel lens 54. This lens having its primary focal point located at the level of laser source 36 (see FIG. 2) enables to rectify incident light beams reaching the screen in directions non-normal thereto towards a normal direction. At the surface of the different portions of the Fresnel lens are also provided microstructures 56 ensuring a diffusion. Microstructures 56 may be present on all the areas of the Fresnel lens in contact with the light beam. In the shown example, microstructures 56 are not formed on the sides of the Fresnel lens normal to plate 50. As a variation, microstructures 56 may be formed on the sides of the Fresnel lens normal to plate 56.

FIG. 5 illustrates the operation of the transmissive diffuser screen of FIG. 4. This drawing illustrates a first light beam 60 reaching laser source 36 at the surface of the transmissive diffuser screen along a direction normal to its surface. Light beam 60 reaches microstructured surface 56 of Fresnel lens 54. Microstructure 56 implies the diffusion of light beam 60, which forms a set of light beams 62 originating from a plurality of secondary sources within plate 50. When light beams 62 reach microstructure 52 on the output surface of the diffuser screen, they diffuse again in a set of beams 64.

Microstructure 56 thus implies forming a plurality of secondary sources 62 having their beams, after diffusion on microstructure 52, exhibiting an attenuated coherence. Indeed, beams 62 travel different distances in plate 50, which at least largely cancels the spatial coherence of the different beams originating from microstructure 52. Thus, at the device output, the obtained beam substantially has an intensity in the form of that of curve 53 of FIG. 3.

In FIG. 5, a second light beam 66 is illustrated, beam 66 reaching the surface of the transmissive diffuser screen with a non-zero angle of incidence. In the same way as for beam 60, beam 66 is diffused at the level of microstructure 56 to form beams 68 in plate 50, and beams 68 diffuse again at the level of microstructure 52 to form a set of output beams 70. The use of Fresnel lens 54 enables to rectify beam 66 towards an observer placed on the output side of the device. The rectification of the incident beam thus still more clearly appears for a still more oblique beam 72 which provides diffused beams 74-76 having the same respective directions as beams 62-64 and 68-70.

The cumulated used of the Fresnel lens and of the two microstructures, on the input side and the output side of the diffuser screen, thus provides a good focusing of incident light beams, limits speckle phenomena, while ensuring the main function of the plate, that is, the diffusion of the incident beam.

When the screen of FIG. 4 is used to replace screen 30 of FIG. 2, the beam originating from mobile laser 36 scans the entire surface of the transmissive diffuser screen according to different angles of incidence. The use of the Fresnel lens thus enables to rectify the rays, while providing a good control of the diffusion.

It should be noted that microstructure 56 is preferably formed of a holographic-type diffuser which enables to control the angles for which light is diffused, these angles corresponding to the width at mid-height of the indicatrix of diffusion. It should also be noted that the diffusion angle of microstructure 56 is selected so that the beam thus diffused by an angle θ generates an image spot on the output side of plate 50 located at a distance e from the input surface of plate 50, compatible with the desired resolution r, that is, satisfying equation: r=2.e.tan(θ/2).

As an example, microstructures 52 and 56 may be formed of holographic films formed at the surface, respectively, of plate 50 and of Fresnel lens 54, topped with a metallization. Such microstructures are particularly known and commercialized by Luminit.

The microstructures may be obtained by molding or by printing. Such microstructures are of pseudo-random nature. As an example, the mold or the printing pattern may be obtained by recording a speckle pattern by a holographic method. The characteristic dimensions of such microstructures are for example an average pitch in the range from 1 to 200 μm, and a depth (or outgrowth height) in the range from 0.5 to 5 μm.

It should be noted that the screen of FIG. 4 may be assembled in different ways. It may in particular be formed of a single transparent block having, on one side, a Fresnel lens and microstructures 56 and, on the other side, microstructures 52, formed thereon. It may also be provided to place, for example, by means of transparent glue, a Fresnel lens having microstructures 56 formed thereon on a transparent plate, the second surface of the transparent plate being microstructured. Finally, microstructures 52 and 56 may also be themselves in the form of films respectively placed respectively at the surface of the Fresnel lens and at the surface of the central transparent plate.

Further, the forming of a Fresnel lens 54 at the surface of the plate easily enables to obtain a lens having a focal distance in the range from 200 to 400 mm, for example, in the order of 300 mm, while having a relatively small bulk (for example, with a pitch in the range from 0.2 to 0.3 mm).

Specific embodiments have been described. Various alterations and modifications will occur to those skilled in the art. A diffusion screen where the optical focusing structure is a Fresnel lens has in particular been provided in the drawings. It should be noted that this lens may be replaced with any optical focusing device, microstructure 56 being then defined on the surface of this optical focusing device.

1. A transmissive diffuser screen comprising a transparent support a first surface of the support being covered with a first diffusive microstructure, and a second surface of the support being covered with an optical focusing structure having its primary focal point arranged at the level of a screen illumination source and having its surface covered with a second diffusive microstructure.

2. The screen of claim 1, wherein the optical focusing structure is a Fresnel lens.

3. The screen of claim 1, wherein the screen illumination source is a screen scanning laser source.

4. The screen of claim 2, wherein the second diffusive microstructure is defined on the surface of each of the convex portions of the Fresnel lens.

5. The screen of any of claim 1, wherein the focusing structure is placed on the support by means of glue.

6. The screen of claim 1, to wherein the support, the optical focusing structure, the first diffusive microstructure, and the second diffusive microstructure are defined in a single block.

7. The screen of any of claim 1, to wherein the first diffusive microstructure and the second diffusive microstructure are formed of films placed at the surface, respectively, of the first side of the support and of the optical focusing structure.

8. The screen of any of claim 1, wherein the optical focusing structure has a focal distance in the range from 200 to 400 mm.

9. A rear projection device, comprising the screen of any of claim 1.

10. A central console of a vehicle, comprising the rear projection device of claim 9.
